(19) United States
(12) Patent Application Publication
(10) Pub. No.: US 2019/0012590 A1
(43) Pub. Date: Jan. 10, 2019

(54) BANK CARD WITH RFID COUNTERFEIT SECURITY, VERIFICATION AND PREPARATION METHODS THEREOF

(71) Applicant: GUANGDONG CHUTIAN DRAGON SMART CARD CO., LTD, Dongguan City (CN)

(72) Inventor: Bo-Sheng WU, Dongguan City (CN)

(21) Appl. No.: 15/675,170

(22) Filed: Aug. 11, 2017

(30) Foreign Application Priority Data
Jul. 10, 2017 (CN) 201710554954.0

(51) Int. Cl. G06K 19/08; G06K 7/10; G06K 19/073; G06K 19/14; G06K 7/00

(52) U.S. Cl. CPC G06K 19/083; G06K 7/10257; G06K 7/0004; G06K 19/14; G06K 19/073

(57) ABSTRACT

The present invention relates to the field of bank card security and specifically discloses a bank card with RFID counterfeit security and its verification method. The bank card includes a RFID tag, an IC chip, an antenna, and a magnetic stripe. The antenna is coupled to a pad in the IC chip; a tag antenna is installed in the RFID tag; the bank card has a card number, and the card number is stored in both IC chip and magnetic stripe. The verification method includes the steps of: binding the unique identification number of the RFID tag, a card number, and data stored in the IC chip and/or the magnetic stripe; uploading the bound data to an authentication server; reading the data of the bank card to be verified; matching and verifying the read data and the bound data.

### FIELD OF INVENTION

The present invention relates to the field of bank card security, in particular to a bank card with RFID counterfeit security and its verification and preparation methods.

### BACKGROUND OF INVENTION

### 1. Description of the Related Art

The events of cloned bank cards and unauthorized uses of bank cards are not uncommon. According to media reports, Japan suffered a loss of up to 3.2 billion yens (approximately equal to 200 million yuans) resulted from domestic ATM cash withdrawals by counterfeit bank cards from April 2016 to March 2017, and it brings serious economic losses to bank card holders. Conventional bank cards are generally divided into two main types, respectively; those using a magnetic stripe as a medium (mostly for foreign use), and those using a combination of a magnetic stripe and an IC as a medium (mostly for domestic use), and these cards have obvious anti-counterfeit loopholes and drawbacks of being forged or cracked easily.

### 2. Summary of the Invention

To overcome the drawbacks and deficiencies of the prior art, it is a primary objective of the present invention to provide a bank card with high security, reliability, and anti-counterfeit performance, and specifically to provide a bank card with RFID counterfeit security.

To achieve the aforementioned and other objectives, the present invention discloses a bank card with RFID counterfeit security, and the bank card comprises a RFID tag, an IC chip, and an antenna, wherein the antenna is coupled to a pad in the IC chip, and a tag antenna is installed in the RFID tag, and the bank card has a card number, and the card number is stored in the IC chip.

Alternatively, the bank card comprises a RFID tag and a magnetic stripe, wherein the tag antenna is installed in the RFID tag, and the bank card has a card number, and the card number is stored in the magnetic stripe.

Alternatively, the bank card comprises a RFID tag, an IC chip, an antenna, and a magnetic stripe, wherein the antenna is coupled to a pad in the IC chip, and a tag antenna is installed in the RFID tag, and the bank card has a card number, and the card number is stored in both IC chip and magnetic stripe.

In a preferred embodiment, the RFID tag is a passive tag with a working frequency of 13.56 MHz, and a communication protocol in compliance with the ISO/IEC 15693.

Further, the RFID tag is embedded into the bank card.

In a preferred embodiment, the IC chip is a dual interface communication interface chip with a working frequency of 13.56 MHz, and a communication protocol in compliance with the ISO/IEC 14443.

Further, the RFID tag is embedded into the bank card; the antenna is a passive antenna embedded into the bank card; and the passive antenna is coupled to two pads in the IC chip by an ultrasonic butt welding process.

The present invention further discloses an anti-counterfeit verification method of a bank card with RFID counterfeit security, and the anti-counterfeit verification method comprises the following steps:

(1) Bind the unique identification number of a RFID tag and a bank card number, data stored in an IC chip, and/or data stored in a magnetic stripe, and store the bound data into an authentication server.

(2) Read the unique identification number of the RFID tag of a bank card to be verified, read the data stored in the IC chip and/or the data stored in the magnetic stripe, and send the read data to the authentication server.

(3) Match and verify the received data and the stored bound data by the authentication server, and determine the bank card to be legitimate if the data are matched, or else determine the bank card to be illegitimate.

The anti-counterfeit verification method further comprises the step of feeding back the verification result to the reading terminal by the authentication server.

Specifically, the unique identification number of the RFID tag of the bank card, the data stored in the IC chip, and/or the data stored in the magnetic stripe are read by an intelligent terminal, and the intelligent terminal supports the ISO/IEC 15693 and ISO/IEC 14443 communication protocols simultaneously.

The present invention further discloses a computer accessible storage medium for storing a computer program, and the computer program is executed by the processor to achieve the aforementioned anti-counterfeit verification method.

The present invention further discloses a preparation method of a bank card with RFID counterfeit security and the preparation method comprises the following steps:

(1) Embed a RFID tag into a bank card.

(2) Embed a magnetic stripe and/or an IC chip into a surface of the bank card, connect a pad of the IC chip to an antenna, and embed the antenna into the bank card.

(3) Print a bank card number onto the surface of the bank card.

In a preferred embodiment, the antenna is coupled to the two pads in the IC chip by an ultrasonic butt welding process.

The present invention has the following advantages:

The invention embeds the RFID tag in the bank card, uses the unique identification number of the RFID tag, the bank card number, and the data stored in the IC chip/magnetic stripe to match and verify the legitimacy of the bank card. Compared with the prior art, the anti-counterfeit solution of the invention is simple, efficient, and accurate.

### BRIEF DESCRIPTION OF THE DRAWINGS

FIG. 1 is a schematic view showing the structural layout of a bank card of an embodiment of the present invention;

FIG. 2 is a schematic view showing the structure of a RFID tag of an embodiment of the present invention;

FIG. 3 is a schematic view of an antenna coupled to a pad of an IC chip in accordance with an embodiment of the present invention; and

FIG. 4 is a schematic view showing the layout of a magnetic strip of an embodiment of the present invention.

### DESCRIPTION OF THE PREFERRED EMBODIMENTS

The above and other objects, features and advantages of this disclosure will become apparent from the following detailed description taken with the accompanying drawings. It is intended that the embodiments and drawings disclosed herein are to be considered illustrative rather than restrictive.

RFID technology with the features of contactless identification, and global unique identification has shown its advantages in identification. Specifically, the RFID tag has a global unique ID number (which is the unique identification number) and this unique identification number serves as a physical address of the RFID tag that can be read but not written. During the manufacturing process of the tag, a ROM is installed, so that the tag cannot be modified or forged to ensure the security and uniqueness of the tag.

The present invention uses the global uniqueness of the RFID tag and binds the bank card number, the information stored in the IC chip of the bank card, and the information stored in the magnetic stripe to achieve a simple, efficient, and accurate anti-counterfeit solution.

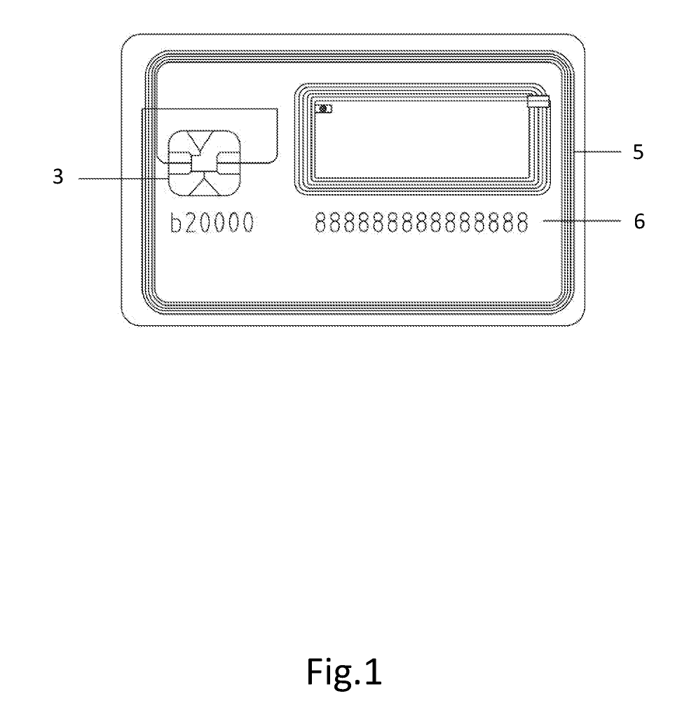

With reference to FIG. 1 for a bank card with RFID counterfeit security in accordance with the first preferred embodiment of the present invention, the bank card comprises a RFID tag 1, an IC chip 3, and an antenna 5, wherein the IC chip 3 has a pad 4 installed therein; the antenna 5 is coupled to the pad 4 in the IC chip 3 and provided for reading the IC chip 3 in a non-contact manner; the RFID tag 1 has a tag antenna 2 installed therein; and the bank card has a card number 6 which is stored in the IC chip 3.

The RFID tag 1 is a passive tag with a working frequency of 13.56 MHz and a communication protocol in compliance with the ISO/IEC 15693.

The RFID tag 1 is embedded into an inner layer of the bank card, so that the RFID tag 1 cannot be seen from the surface of the bank card. In addition, the RFID tag 1 is installed at a position other than the positions of the IC chip 3 and the bank card number 6. In this preferred embodiment, the size of the RFID tag 1 is controlled to be within the range of 45×20 mm.

The IC chip 3 is a dual interface communication interface chip embedded into a surface of the bank card, and the IC chip 3 has a working frequency of 13.56 MHz and a communication protocol in compliance with the ISO/IEC 14443. The so-called dual interface communication interface chip refers to those having two reading interfaces (one is the contact interface, and the other one is the non-contact reading interface). The IC chip 3 is designed as the dual interface communication interface chip to achieve the effect of reading the IC chip 3 in different ways. In addition, the RFID tag 1 also reads in a non-contact manner and has several working frequencies. In this preferred embodiment, the working frequency is 13.56 MHz, and the working frequencies of the RFID tag 1 and the IC chip are both designed to be 13.56 MHz to facilitate the installation of the intelligent reading terminal (wherein the setting of only one working frequency is required). To prevent any conflict or confusion of reading, two different communication protocols are set. In this preferred embodiment, the communication protocol of the IC chip 3 is ISO/IEC 14443, and the communication protocol of the RFID tag 1 is ISO/IEC 15693, so that both IC chip 3 and RFID tag 1 can work at the same frequency simultaneously without conflicts.

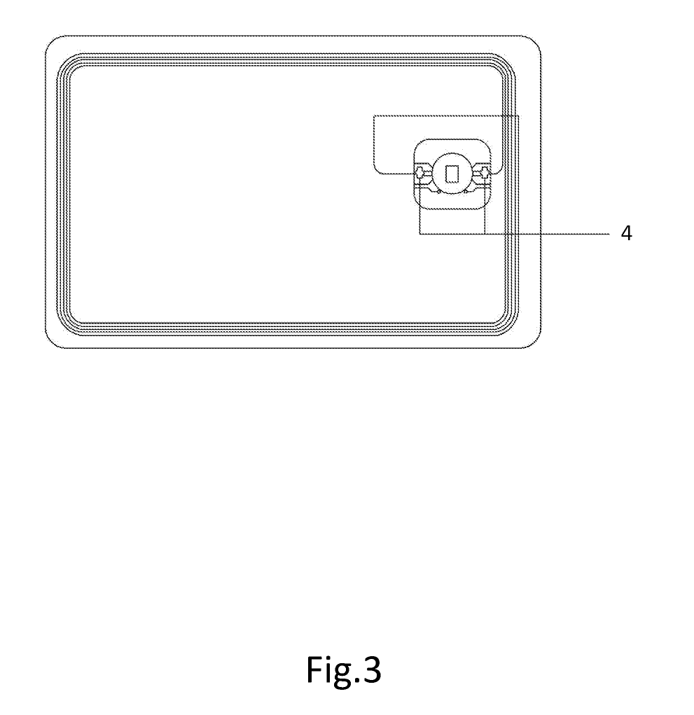

The antenna 5 is a passive antenna embedded into an inner layer of the bank card, so that the antenna 5 cannot be seen from the surface of the bank card, wherein the passive antenna is coupled to the two pads 4 in the IC chip 3 by an ultrasonic butt welding process as shown in FIG. 3.

The bank card number 6 includes a set of variable data, and the variable data can be written into a buffer area of the IC chip 3 through an intelligent device to ensure that the read data stored in the IC chip 3 is corresponsive to the bank card number 6.

At present, there are different types of conventional bank cards such as the bank cards with an IC chip, the bank cards with a magnetic stripe card, and the bank cards with a combination of an IC chip and a magnetic stripe, so that different types of bank cards are prepared according to the needs of different regions.

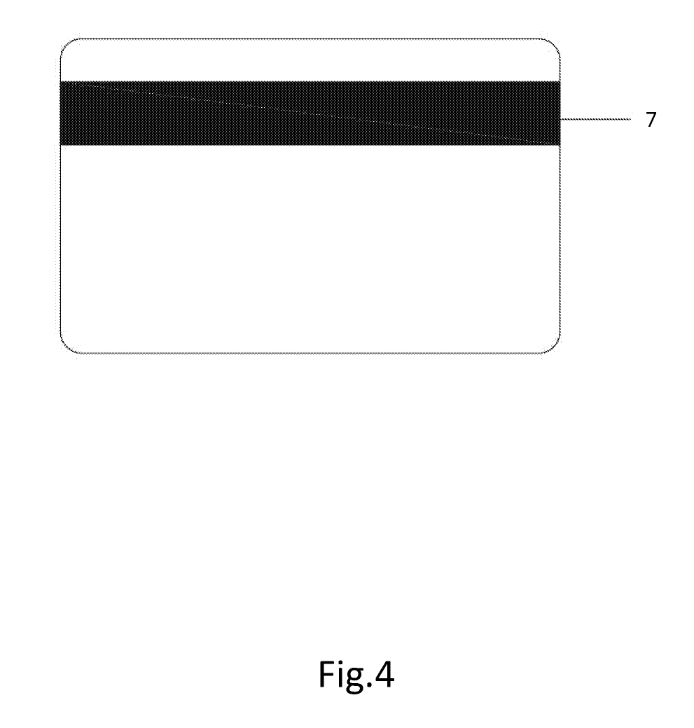

In the second preferred embodiment of the present invention, a magnetic stripe 7 is added to the bank card of the first preferred embodiment, and the magnetic stripe 7 is embedded into a surface of the bank card and can be seen visually as shown in FIG. 4.

Preferably, the magnetic stripe 7 is a high-resistance magnetic stripe.

Further, an intelligent device may be used to write the bank card number 6 into the buffer area of a magnetic track of the magnetic stripe 7 to ensure that the data stored in the magnetic stripe 7, the data stored in the IC chip 3, and the bank card number 6 are corresponsive to one another. The remaining technical characteristics of this preferred embodiment are the same as those of the first preferred embodiment, and thus they will not be repeated.

In the third preferred embodiment of the present invention, when a certain region has selected to use a magnetic stripe card, it no longer needs to install the IC chip 3, and simply needs to install the magnetic stripe 7 only. In other words, the bank card has a RFID tag 1, a magnetic stripe 7, and a card number 6, and the card number 6 is stored in the magnetic stripe 7, and the tag antenna 2 is installed in the RFID tag 1.

The remaining technical characteristics of this preferred embodiment are the same as those of the second preferred embodiment, and thus they will not be repeated.

In the fourth preferred embodiment of the present invention, the present invention further provides an anti-counterfeit verification method of a bank card with RFID counterfeit security, and the anti-counterfeit verification method comprises the following steps:

When a bank issues an IC chip bank card, the unique identification number of the RFID tag 1 of the bank card, the bank card number 6, the data stored in the IC chip 3 are bound, and the bound data are uploaded and stored in an authentication server. The IC chip 3 has a bank card number 6 stored therein. Further, the bank may store personal identification information including personal information such as name and ID number, etc into the IC chip 3, and the information and data, the unique identification number of the RFID tag 1, and the bank card number 6 are bound.

Similarly, when the bank issues a magnetic stripe bank card, and the unique identification number of the RFID tag 1 of the bank card, the bank card number 6, the data stored in the magnetic stripe 7 are bound, and then the bound data are uploaded and stored in the authentication server. The data stored in the magnetic stripe 7 include but not limited to a bank card number 6, and a name and an ID number of the bank card holder.

When a bank issues a bank card including an IC chip and a magnetic stripe, the unique identification number of the RFID tag 1 of the bank card, the bank card number 6, the data stored in the IC chip 3, and the data stored in the magnetic stripe 7 are bound, and then the bound data are uploaded and stored in the authentication server.

When the bank card is used, an intelligent terminal (such as a card reader or a mobile terminal with a card reading function) is provided for reading the information of the bank card. To achieve the effect of reading the information of the anti-counterfeit bank card, the intelligent terminal has to support the communication protocols of the ISO/IEC15693 and the ISO/IEC14443 simultaneously, and then the intelligent terminal sends the read unique identification number of the RFID tag 1, the data stored in the IC chip 3, and the data stored in the magnetic stripe 7 to the authentication server.

The authentication server matches and verifies the received data with the pre-stored bound data. If the data are matched, then the bank card will be determined to be legitimate, or else the bank card will be determined to be illegitimate. The authentication server feeds back the verification result to the intelligent terminal to facilitate the intelligent reading terminal to timely know whether or not the bank card is legitimate, so as to achieve the anti-counterfeit effect.

Persons having ordinary skill in the art should understand that a part of or all steps of the aforementioned methods can be completed by program instructions and related hardware, and the program may be stored into a computer readable storage medium. When the program is executed, the steps of the aforementioned methods of the preferred embodiments are carried out, and the aforementioned storage medium includes a ROM, a RAM, a floppy disk, an optical disk, or any other medium capable of storing program codes.

In this embodiment of the present invention, the RFID tag is embedded into the bank card, and the global unique identification number of the RFID tag is used, and the bank card number, the data stored in the IC chip, and the data stored in the magnetic stripe are combined to match and verify the legitimacy of the bank card, and the anti-counterfeit verification method is simple, efficient, and accurate.

In this embodiment of the present invention, an intelligent terminal reads an identification number of the RFID tag, data stored in the IC chip, or data stored in the magnetic stripe are used. Since the identification ID of the RFID tag is globally unique and unchangeable, and the bank card number stored in the IC chip or the magnetic stripe is also unique, so that the identification ID of the RFID tag of the legitimate bank card is matched with the bank card number. For an illegitimate bank card, information such as the bank card number is copied and stored in the IC chip or magnetic stripe, but the identification ID of the RFID tag cannot be copied, so that the illegitimate bank card cannot pass the verification during the authentication process, and an accurate determination on a legitimate card or an illegitimate card can be made to achieve the high accuracy of verification. In addition, the identification ID of the RFID tag is matched and verified. If the identification ID is not matched, the bank card will be determined as an illegitimate card, and such verification conclusion can be made efficiently and effectively.

In summation of the description above, the present invention prevents the information stored in the magnetic stripe or chip from being read, copied, or forged by unauthorized persons, so as to improve the security and anti-counterfeit performance of bank card significantly. The aforementioned method in accordance with the preferred embodiments of the present invention directly uses the RFID identification number, the card number and stored data to match and verify the legitimacy of the bank card, and an intelligent terminal is used to read the aforementioned data. Once if any of the data does not match, then the bank card is determined to be an illegitimate bank card. Compared with the prior art (generally using complicated encryption verification algorithm to encrypt data to achieve the anti-counterfeit effect) the present invention provides a bank card with counterfeit security and its anti-counterfeit verification method with the features of high simplicity, efficiency and accuracy.

In the fifth embodiment of the present invention, a preparation method of a bank card with RFID counterfeit security is disclosed, and the preparation method comprises the following steps:

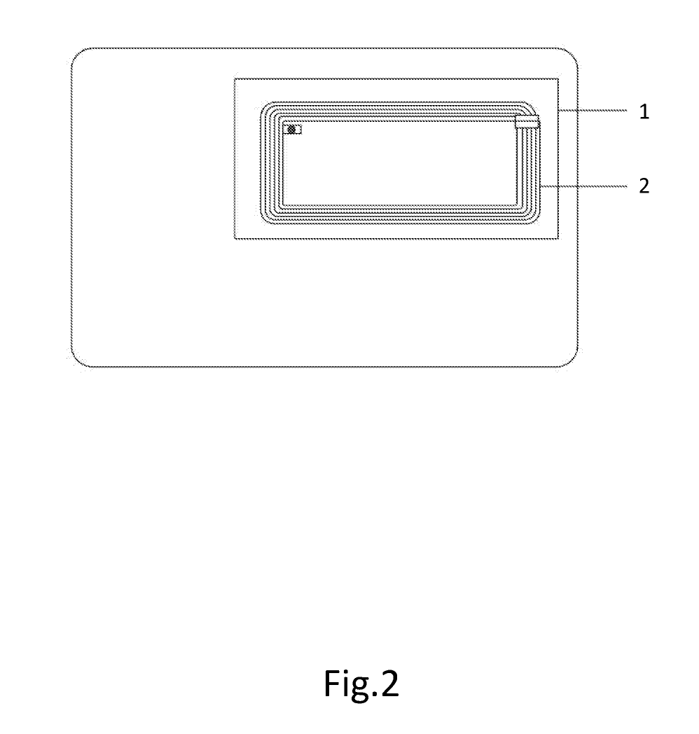

The RFID tag 1 and the antenna 5 are embedded into the bank card as shown in FIG. 1, wherein the RFID tag 1 includes a tag antenna 2 (as shown in FIG. 2), and the size of the RFID tag 1 is smaller than the size of the antenna 5 as shown in FIG. 1, wherein the striped box at the upper right corner is the RFID tag 1, and the striped box connected to the IC chip 3 is the antenna 5; and the RFID tag 1 is embedded into an inner layer of the bank card, so that the RFID tag 1 cannot be seen on the bank card surface.

The IC chip 3 is embedded into the bank card surface as shown in FIG. 1, and the embedding position of the IC chip 3 complies with the ISO/IEC7816 standard; and the IC chip 3 generally includes two pads 4, and the pads 4 of the IC chip 3 are coupled to the antenna 5 as shown in FIG. 3.

The bank card number 6 is printed onto the bank card surface, wherein the card number may be printed by embossing, lithography, gravure, or laser etching, etc.

The bank card may have a magnetic stripe 7 embedded into the bank card surface as shown in FIG. 4, and the embedding position complies with the ISO/IEC 7811 standard.

The aforementioned steps may be carried out regardless of their order and may be operated according to actual need or convenience.

In general, the IC chip 3 and the bank card number 6 are disposed at the first layer of the bank card which is a bank card surface (or the front side of the bank card); the antenna 5 is disposed at the second layer of the bank card, wherein the second layer is situated under the first layer; the RFID tag 1 is disposed at the third layer, wherein the third layer is situated under the second layer; and the magnetic stripe 7 is disposed at the fourth layer, wherein the fourth layer is situated under the third layer, and the fourth layer is also the surface layer of the bank card (or the backside of the bank card) as shown in FIG. 4.

While the invention has been described by means of specific embodiments, numerous modifications and variations could be made thereto by those skilled in the art without departing from the scope and spirit of the invention set forth in the claims.

1. A bank card with RFID counterfeit security comprising:
a RFID tag;
a magnetic stripe;
the RFID tag comprising a tag antenna;
a card number; and
the card number being stored in the magnetic stripe.

2. The bank card with RFID counterfeit security according to claim 1 comprising:
the RFID tag being a passive tag with a working frequency of 13.56 MHz, and a communication protocol in compliance with the ISO/IEC 15693.

3. (canceled)

4. The bank card with RFID counterfeit security according to claim 1 comprising:
the RFID tag being embedded into the bank card;
an antenna;
the antenna being a passive antenna;
the passive antenna being embedded into the bank card;
an IC chip;
the IC chip comprising two pads; and
the passive antenna being coupled to the two pads by an ultrasonic butt welding process.

5. An anti-counterfeit verification method of a bank card with RFID counterfeit security, comprising the steps of:
binding the unique identification number of a RFID tag and a bank card number, data stored in an IC chip, and/or data stored in a magnetic stripe, and storing the bound data into an authentication server;
reading the unique identification number of the RFID tag of a bank card to be verified, reading the data stored in the IC chip and/or the data stored in the magnetic stripe, and sending the read data to the authentication server; and
matching and verifying the received data and the stored bound data by the authentication server, and determining the bank card to be legitimate if the data are matched, or else determining the bank card to be illegitimate.

6. The anti-counterfeit verification method according to claim 5, further comprising the step of feeding back the verification result to the reading terminal by the authentication server.

7. The anti-counterfeit verification method according to claim 5, wherein the unique identification number of the RFID tag of the bank card, the data stored in the IC chip, and/or the data stored in the magnetic stripe are read by an intelligent terminal, and the intelligent terminal supports the ISO/IEC 15693 and ISO/IEC 14443 communication protocols simultaneously.

8. A computer accessible storage medium, for storing a computer program, and the computer program being executed by a processor to achieve the anti-counterfeit verification method according to any one of claims 5 to 7.

9. A preparation method of a bank card with RFID counterfeit security, comprising the steps of:
embedding a RFID tag into a bank card;
embedding a magnetic stripe and/or an IC chip into a surface of the bank card, connecting a pad of the IC chip to an antenna, and embedding the antenna into the bank card; and
printing a bank card number onto the surface of the bank card.

10. The bank card preparation method according to claim 9, wherein the antenna is coupled to the two pads in the IC chip by an ultrasonic butt welding process.

11. A bank card with RFID counterfeit security comprising:
a RFID tag;
an IC chip;
an antenna;
the IC chip comprising two pads;
the antenna being coupled to the two pads;
the RFID tag comprising a tag antenna;
a card number; and
the card number being stored in the IC chip.

12. The bank card with RFID counterfeit security according to claim 11 comprising:
the RFID tag being a passive tag with a working frequency of 13.56 MHz, and a communication protocol in compliance with the ISO/IEC 15693.

13. The bank card with RFID counterfeit security according to claim 11 comprising:
the IC chip being a dual interface communication interface chip with a working frequency of 13.56 MHz, and a communication protocol in compliance with the ISO/IEC 14443.

14. The bank card with RFID counterfeit security according to claim 11 comprising:
the RFID tag being embedded into the bank card;
the antenna being embedded into the bank card;
the antenna being a passive antenna; and
the passive antenna being coupled to the two pads by an ultrasonic butt welding process.

15. The bank card with RFID counterfeit security according to claim 11 comprising:
a magnetic stripe; and
the card number being stored in the magnetic stripe.
